(19) United States
(12) Patent Application Publication
(10) Pub. No.: US 2010/0181751 A1
(43) Pub. Date: Jul. 22, 2010

(54) Book with Multiple Containers

(76) Inventor: Karen Guinn Robertson, New South Wales (AU)

Correspondence Address: MICHAEL MOLINS;MOLINS & CO., SUITE 5, LEVEL 6, 139 MACQUARIE ST, SYDNEY NSW, 2000, AU

(21) Appl. No.: 12/665,313

(22) PCT Filed: Jun. 25, 2008
(86) PCT No.: PCT/AU08/00920

§ 371 Date: Dec. 17, 2009

(30) Foreign Application Priority Data
Jun. 27, 2007 (AU) 2007903445

(51) Int. Cl. B42D 1/00

(52) U.S. Cl. 281/15.1

(57) ABSTRACT

An interactive book has a front cover, a back cover, bound text pages and multiple accompanying containers that are attached. Each container is adapted to hold an object or a set of objects such as toys that may relate to a certain stage of the story of the book.

### FIELD OF THE INVENTION

This invention relates to a book, in particular, a book having containers that hold objects.

### BACKGROUND OF THE INVENTION

For some people, such as small children, reading can be an uninteresting activity. One way to encourage reading is to provide interactive features that help engage a reader's attention. This may be done by providing objects such as toys that relate to various stages of the story in the book. However, seeing an object that is meant for a later part of the story may spoil the surprise for a reader who has only read up to an earlier stage of the story. In a more general way, a book can be made desirable by combining it with compartments.

### OBJECT AND SUMMARY OF THE INVENTION

It is an object of the present invention to provide an interactive book.

It is another object of the present invention to provide interactive features that correspond to different stages of the book and are revealed at different times.

It is also an object to provide a book with individual compartments.

### BRIEF DESCRIPTION OF THE DRAWING FIGURES

In order that the invention be better understood, reference is now made to the following drawing figures in which:

FIG. 1 is a perspective view of a book with multiple containers attached to the spine;

FIG. 2 is a perspective view of a different embodiment of the containers;

FIG. 3 is a perspective view of a book with multiple containers that are attached on the back cover and located to the right of the book;

FIG. 4 is a perspective view of a book with multiple containers that are attached on the back cover and located above the book;

FIG. 5 is a perspective view of a book with multiple containers that are attached on the back cover and located below the book;

FIG. 6 is a side elevation view of a container that is attached to a book using hook and loop fastener strips; and

FIG. 7 is a schematic perspective view of a binder with compartments and an insert.

### BEST MODE AND OTHER EMBODIMENTS

In the following specification, the directional references of right, left, top, and bottom are made with regard to the front cover of a book.

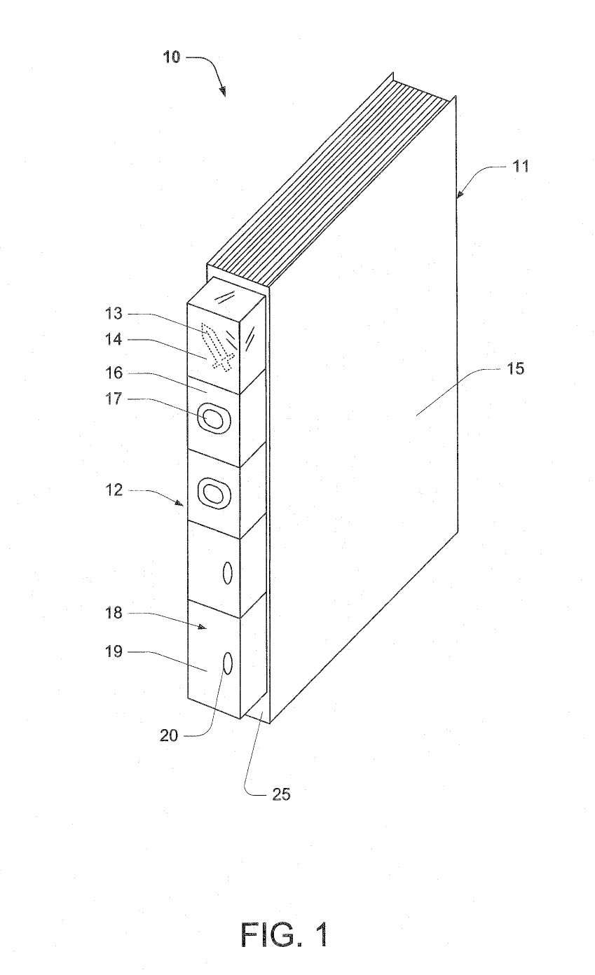

As shown in FIG. 1, an interactive book 10 comprises a front cover 15, a back cover, bound text pages 11 and multiple accompanying containers 12 that are attached to one of the covers, the spine or the bound text pages 11. Each container is adapted to hold an object or a set of objects such as toys that relate to a certain stage of the story of the book. Objects may include toys, puzzle pieces, model pieces, stickers, craft pieces, magnetic objects, magic tricks etc. Each container can be opened individually. As the reader progresses to various parts of the story, he or she may (but not necessarily) be directed by a command or clue found in the text to open a container to uncover various objects relevant to the storyline. In some embodiments, at lest one container may be transparent so that the content 13 of at least one container 14 is visible from the front 15 or rear of the book 10 or the spine. This offers a visual clue, given from a closed container, that the items referred to in the interactive book may be found in the other containers 12.

The multiple containers 12 may be arranged in different ways and can take different shapes. In the embodiment shown in FIG. 1, they are rectangular drawers that are stacked together. Each drawer 16 has a handle 17 for pulling out the container 16. The containers may be cabinets or boxes that are stacked together. In this case, each cabinet 18 has a hinged door or lid 19 that can be opened using a handle 20. Hinges may be integrally moulded with its container and door or lid.

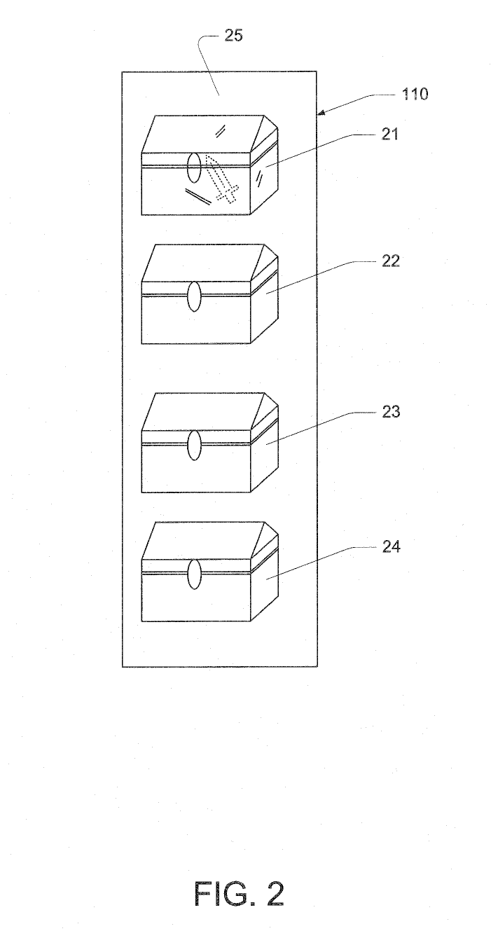

Alternatively, as shown in FIG. 2, they can be individual containers 21, 22, 23, 24 that are attached to the book, or provided separately on an attachable substrate 110. As suggested by FIG. 2, the multiple containers may be moulded together and integrally with the substrate 110 as an integral or one piece moulding. The substrate and containers form a single piece or a single assembly that can be attached in a variety of ways. The multiple containers 12 may further take different shapes. For example each container can resemble a treasure chest with a hinged lid, for example and integrally moulded hinged lid. The shape of the container may vary depending on the story. For example, the containers can look like treasure chests if the book relates to an adventure story. They can look like eggs if the interactive book relates to a story about farm animals. In FIGS. 1 and 2, the containers are attached (directly or indirectly) to the spine 25 of the bound text pages 11. However, the containers may be attached differently, as long as the part of the bound text pages or a cover of the book that supports the containers is made of a material rigid enough for supporting the weight of the containers.

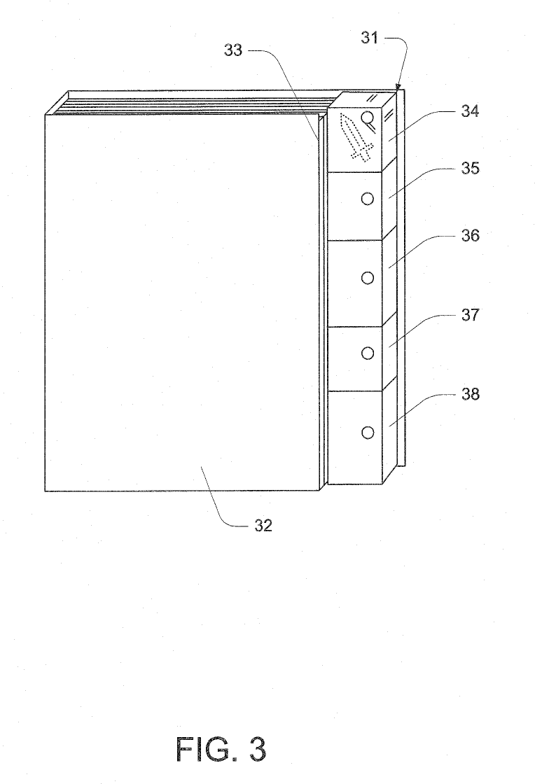

Referring to FIG. 3, the rigid or semi-rigid back cover 31 of the bound text pages 32 is wider than the front cover 33 of the bound text pages. The back cover 31 has a margin 39 that extends beyond the right edge 34 of the front cover 33. The containers 34-38 are attached to the upper surface of the margin 39 of the back cover 31 and are located to the right of the bound text pages 32. It should be understood that the same arrangement can be modified, for publications made in countries where book bindings are conventionally provided along the right hand side. Specifically, the back cover extends beyond the left edge of the front cover, and the containers are located to the left of the bound text pages.

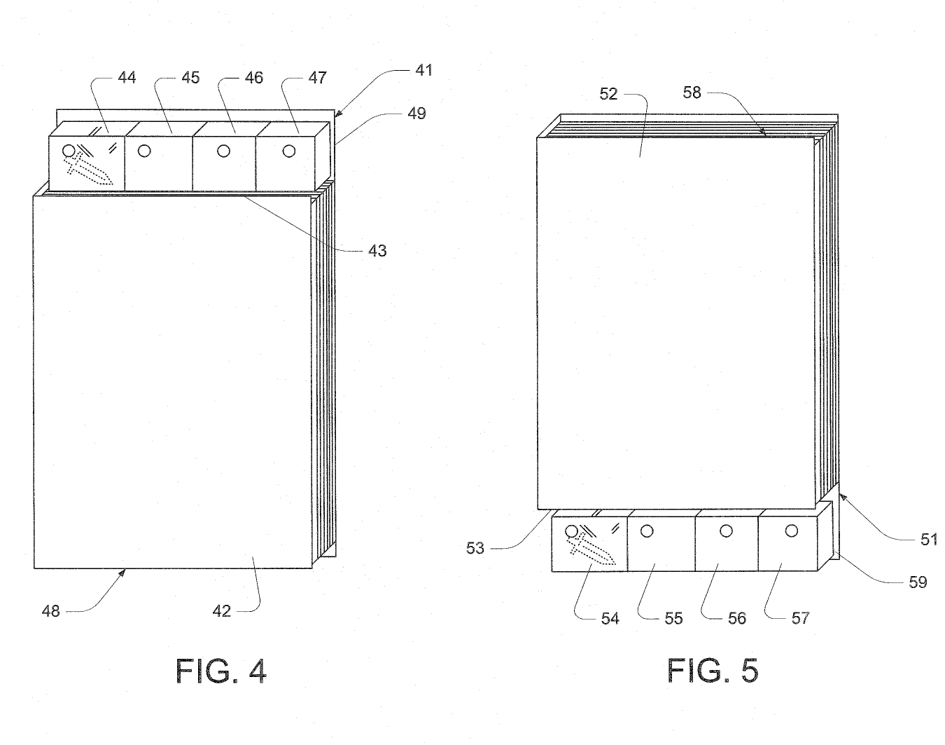

In the embodiment depicted in FIG. 4, the back cover 41 has a greater height than the front cover 42 and has an upper margin 49 that extends above the top edge 43 of the front cover 42. The containers 44-47 are attached to the upper margin 49 of the back cover 41 and are located above the bound text pages 48. In the embodiment depicted in FIG. 5, the back cover 51 has a lower margin 59 that extends below the bottom edge 53 of the front cover 52. The containers 54-57 are attached to the lower margin 59 of the back cover 51 and are located below the bound text pages 58.

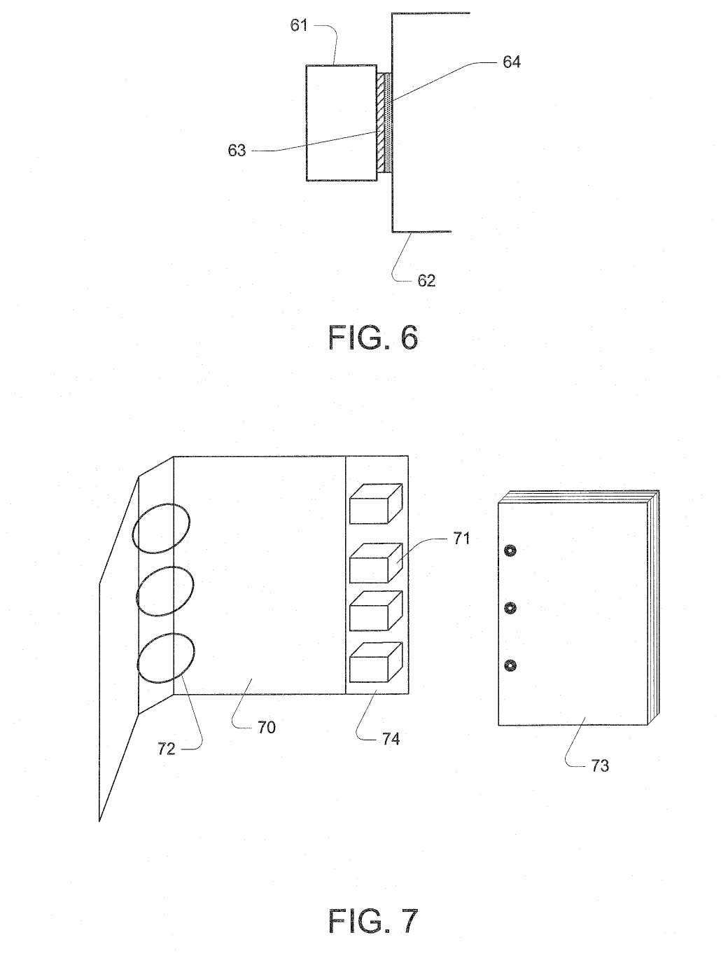

There is no restriction on way the containers are attached to the book. For example, the containers may be permanently affixed to the any outward facing or exterior portion of the book, its spine or covers. The containers may also be removably attached to the book or the substrate that is attached to the book. Referring to FIG. 6, the container or a substrate 61 may be attached to the book 62 using cooperating hook and loop fastening 63, 64.

As shown in FIG. 7, the teachings of the present invention may be applied to a binder 70. A binder incorporating compartments 71 may be fabricated using the teachings provided above. The binder 70 has openable rings 72 or another conventional mechanism for accepting an insert of a single sheet or an insert 73 comprising 2 or more pages, such as hole punched pages. The insert 73 takes the place of the bound pages described above, but the binder can be re-used with a different insert 73 representing a different story. Different objects for the compartments may be supplied with an insert when the insert 73 is sold separately. The binder may be adapted to accept different compartments after purchase, either individually or all together when supplied on or incorporated with a substrate 74 as discussed above.

While the present invention has been disclosed with reference to particular details of construction, these should be understood as having been provided by way of example and not as limitations to the scope or spirit of the invention. For instance, the containers may be of any number, of different types, have different shapes and may be arranged in one or more rows, in a stack or other array, connected to one another or individually. The mechanism by which the containers are attached to the book may also be changed without limiting the invention. The containers may be formed individually or as a unitary moulding with an integral substrate that may be attached to a book.

What is claimed is:

1. A book comprising:
a front cover, a back cover, and bound text pages;
multiple containers being attached to one of the covers;
each container being adapted to hold an object.

2. The book of claim 1, wherein each container can be opened individually.

3. The book of claim 1, wherein the content of at least one container is visible from the front of the book.

4. The book of claim 1, wherein the content of at least one container is visible when viewing a spine of the book.

5. The book of claim 1, wherein:
the back cover of the book is wider than the front cover;
the back cover having a margin that extends beyond an edge of the front cover;
the containers being attached to the margin.

6. A book comprising:
a front cover, a back cover, a spine and bound text pages;
multiple containers being attached to the spine;
each container being adapted to hold an object.

7. The book of claim 6, wherein each container can be opened individually.

8. The book of claim 7, wherein the content of at least one container is visible from a side of the book.

9. The book of claim 6, wherein the content of at least one container is visible when viewing a spine of the book.

10. The book of claim 1, wherein the containers are boxes with integrally hinged lids.

11. The book of claim 6, wherein the containers are boxes with integrally hinged lids.

12. The book of claim 1, wherein the containers are moulded together onto a substrate that is attached to the book.

13. The book of claim 6, wherein the containers are moulded together onto a substrate that is attached to the book.

14. The book of claim 1, wherein the containers have different shapes.

15. The book of claim 6, wherein the containers have different shapes.

16. The book of claim 1, wherein:
the back cover of the book is higher than the front cover;
the back cover thus forming a margin that extends beyond an edge of the front cover;
the containers being attached to the margin.

17. The book of claim 1, wherein the containers are attached to the book by hook and loop fastening.

18. The book of claim 6, wherein the containers are attached to the book by hook and loop fastening.

19. An interactive book apparatus comprising:
a book having a front cover, a back cover, and a plurality of pages; and
a plurality of interconnected individually openable containers coupled to the book, wherein each container being adapted to hold an object.

20. The apparatus according to claim 19, wherein the plurality containers are releasably attached to the book.
